(19) United States
(12) Patent Application Publication
(10) Pub. No.: US 2016/0099632 A1
(43) Pub. Date: Apr. 7, 2016

(54) Motor Housing with Integral Gear Housing

(71) Applicant: ATIEVA, INC., Redwood City, CA (US)

(72) Inventor: Peter Dore Rawlinson, Worcestershire (GB)

(73) Assignee: ATIEVA, INC., Redwood City, CA (US)

(21) Appl. No.: 14/503,683

(22) Filed: Oct. 1, 2014

(51) Int. Cl. H02K 7/116; H02K 5/15

(52) U.S. Cl. CPC H02K 7/116; H02K 5/15

(57) ABSTRACT

A motor assembly is provided that utilizes a single piece drive gear and bearing enclosure configured so that the end wall of the enclosure also serves as one of the motor's end caps, thereby helping to minimize coaxial misalignment between the input drive shaft of the primary drive gear and the motor's rotor shaft. To further minimize misalignment, three coaxial bearing assemblies are used, where the first and second bearing assemblies support the rotor shaft and the second and third bearing assemblies support the input drive shaft.

### FIELD OF THE INVENTION

The present invention relates generally to the electric motor assembly of an EV and, more particularly, to an assembly designed to minimize the mismatch between an electric motor and the primary drive gear, thereby reducing drive train deterioration and extending drive train longevity and reliability.

### BACKGROUND OF THE INVENTION

In response to the demands of consumers who are driven both by ever-escalating fuel prices and the dire consequences of global warming, the automobile industry is slowly starting to embrace the need for ultra-low emission, high efficiency cars. While some within the industry are attempting to achieve these goals by engineering more efficient internal combustion engines, others are incorporating hybrid or all-electric drive trains into their vehicle line-ups. To meet consumer expectations, however, the automobile industry must not only achieve a greener drive train, but must do so while maintaining reasonable levels of performance, range, reliability, safety and cost.

The most common approach to achieving a low emission, high efficiency car is through the use of a hybrid drive train in which an internal combustion engine (ICE) is combined with one or more electric motors. In general there are three types of hybrid drive trains: parallel hybrid, series-parallel hybrid, and series hybrid. In a parallel hybrid drive train, the power required to propel the vehicle may be provided by the internal combustion engine or the electric motor, either individually or together. In a series-parallel hybrid drive train, propulsive power is provided by both the internal combustion engine and the electric motor using a power splitter such as a planetary gear set. In a series hybrid drive train, propulsive power is only supplied by the electric motor and the internal combustion engine, which is coupled to a generator, is only used to charge the batteries as necessary.

While hybrid vehicles provide improved gas mileage and lower vehicle emissions than a conventional ICE-based vehicle, due to their inclusion of an internal combustion engine they still suffer from many of the inherent limitations of such a power source. For example, during operation the vehicle still emits harmful pollution, albeit at a reduced level compared to a conventional vehicle. Additionally, due to the inclusion of both an internal combustion engine and an electric motor(s) with its accompanying battery pack, the drive train of a hybrid vehicle is typically much more complex, resulting in increased cost and weight. Accordingly, several vehicle manufacturers are designing vehicles that only utilize an electric motor, or multiple electric motors, thereby eliminating one source of pollution while significantly reducing drive train complexity.

In general, the simplicity of an electric motor-based drive train results in improved reliability over that achievable with an ICE-based drive train. Unfortunately, vibrations within the drive train as well as minor mismatches between the electric motor's drive shaft and the gearbox's output shaft can lead to the premature failure of various drive train components such as the bearing assemblies. Accordingly, what is needed is a motor assembly that reduces drive train deterioration, thereby extending system longevity and reliability. The present invention provides such a motor assembly.

### SUMMARY OF THE INVENTION

The present invention provides a motor assembly comprised of (i) a stator contained within a motor enclosure, the motor enclosure including a motor casing, a first end cap and a second end cap; (ii) a rotor shaft passing between the first end cap and the second end cap of the motor enclosure; (iii) a rotor mounted to the rotor shaft; (iv) a drive gear input shaft that is coaxial with the rotor shaft; (v) a drive gear mounted to the drive gear input shaft; (vi) a drive gear enclosure that includes a first drive gear enclosure end wall and a second drive gear enclosure end wall and a drive gear enclosure side wall, where the drive gear enclosure side wall connects the first drive gear enclosure end wall to the second drive gear enclosure end wall, where the drive gear enclosure is fabricated as a single piece unit, where the drive gear is contained within the drive gear enclosure, where the drive gear input shaft passes between the first drive gear enclosure end wall and the second drive gear enclosure end wall, where the first drive gear enclosure end wall serves as the second end cap of the motor enclosure, where the drive gear enclosure is further comprised of a drive gear access aperture, and where the drive gear access aperture is located in the drive gear enclosure side wall; (vii) a first bearing assembly supporting a first end portion of the rotor shaft, where the first bearing assembly is mounted within the first end cap; (viii) a second bearing assembly interposed between the rotor and the drive gear, where the second bearing assembly supports a second end portion of the rotor shaft and a first end portion of the drive gear input shaft, where the second bearing assembly is mounted within the first drive gear enclosure end wall, and where no additional bearing assemblies are interposed between the rotor and the drive gear; and (ix) a third bearing assembly supporting a second end portion of the drive gear input shaft, where the third bearing assembly is mounted within the second drive gear enclosure end wall. The assembly may be further comprised of an outer gearbox casing attached to the first drive gear enclosure end wall.

In one aspect, the end section of the second end portion of the rotor shaft may be configured to fit within the bore of the end section of the first end portion of the drive gear input shaft. The end section of the rotor shaft may include a male spline and the bore of the end section of the drive gear input shaft may include a female spline configured to match the male spline of the rotor shaft. The end section of the rotor shaft may include a tapered region configured to fit within the bore of the end section of the drive gear input shaft. The tapered region may include at least one step and the bore of the drive gear input shaft may include at least one feature configured to align with the at least one step upon insertion of the end section of the rotor shaft into the bore of the end section of the drive gear input shaft.

In another aspect, the end section of the first end portion of the drive gear input shaft may be configured to fit within the bore of the end section of the second end portion of the rotor shaft. The end section of the drive gear input shaft may include a male spline and the bore of the end section of the rotor shaft may include a female spline configured to match the male spline of the drive gear input shaft. The end section of the drive gear input shaft may include a tapered region configured to fit within the bore of the end section of the rotor shaft. The tapered region may include at least one step and the bore of the rotor shaft may include at least one feature configured to align with the at least one step upon insertion of the end section of the drive gear input shaft into the bore of the end section of the rotor shaft.

In another aspect, the rotor shaft and the drive gear input shaft may be fabricated as a single drive shaft. Additionally, the single drive shaft and the drive gear may be fabricated as a single piece drive gear unit.

In another aspect, the drive gear input shaft may include a male spline and the drive gear may include a female spline configured to match the male spline of the drive gear input shaft.

In another aspect, at least one of the first, second and third bearing assemblies may be comprised of a two piece thin wall bearing.

In another aspect, the first drive gear enclosure end wall may include a positioning feature used to align the first drive gear enclosure end wall with the motor casing during assembly.

In another aspect, the outer surface of the first end portion of the drive gear input shaft may be in contact with the second bearing assembly, where the first end portion of the drive gear input shaft is distal from the second end portion of the drive gear input shaft; alternately, the outer surface of the second end portion of the rotor shaft may be in contact with the second bearing assembly, where the second end portion of the rotor shaft is distal from the first end portion of the rotor shaft; alternately, the juncture between the rotor shaft and the drive gear input shaft may be positioned within the second bearing assembly.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 provides a simplified cross-sectional view of the primary elements of a conventional motor and gearbox assembly in which the motor and gearbox are contained within separate housings;

FIG. 2 provides a simplified cross-sectional view of a motor/gearbox assembly with the housing and bearing assemblies in accordance with the present invention;

FIG. 3 provides a perspective view of the rigid, single piece enclosure used to house the primary drive gear;

FIG. 4 provides a cross-sectional view of the rigid, single piece gear housing shown in FIGS. 2 and 3, this view illustrating access to the primary drive gear via the opening in the housing;

FIG. 5 provides a simplified cross-sectional view of a motor/gearbox assembly similar to that shown in FIG. 2, modified to position the juncture of the rotor shaft and the gearbox input shaft adjacent to the inner race surface of one of the bearing assemblies;

FIG. 6 provides a simplified cross-sectional view of a motor/gearbox assembly similar to that shown in FIG. 2, modified to position the juncture of the rotor shaft and the gearbox input shaft within the confines of the primary drive gear housing;

FIG. 7 provides a simplified cross-sectional view of a motor/gearbox assembly similar to that shown in FIG. 2, modified to use a single shaft as both the rotor shaft and the primary drive gear input shaft;

FIG. 8 provides a simplified cross-sectional view of a motor/gearbox assembly similar to that shown in FIG. 7, where the primary drive gear is integral to the rotor shaft;

FIG. 9 provides a simplified cross-sectional view of a motor/gearbox assembly similar to that shown in FIG. 8, except that the bearing assembly located between the rotor assembly and the primary drive gear is not readily serviceable;

FIG. 10 provides a simplified cross-sectional view of a motor/gearbox assembly similar to that shown in FIG. 9, except that due to the use of a multi-piece thin wall bearing located between the rotor assembly and the primary drive gear all three bearing assemblies are readily serviceable;

FIG. 11 provides a simplified cross-sectional view of a motor/gearbox assembly similar to that shown in FIG. 7, except that a positioning feature and a mounting flange have been added to the primary drive gear housing; and

FIG. 12 provides a simplified cross-sectional view of the motor/gearbox assembly shown in FIG. 11 with an attached outer gearbox casing.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, integers, steps, operations, elements, and/or components, but do not preclude the presence or addition of one or more other features, integers, steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps or calculations, these steps or calculations should not be limited by these terms, rather these terms are only used to distinguish one step or calculation from another. For example, a first calculation could be termed a second calculation, similarly, a first step could be termed a second step, similarly, a first component could be termed a second component, all without departing from the scope of this disclosure.

The motor and gearbox assemblies described and illustrated herein are generally designed for use in a vehicle using an electric motor, e.g., an electric vehicle (EV), and may be used with a single speed transmission, a dual-speed transmission, or a multi-speed transmission.

FIG. 1 provides a cross-sectional view of the primary elements of a conventional motor and gearbox assembly 100 in which the motor and gearbox are contained within separate, but connected, housings. In general, the motor housing is a multi-piece housing typically comprised of a cylindrical motor casing 101 that is mechanically coupled to front and rear end caps 103 and 105, respectively. The motor's core assembly, which is supported on either end by bearing assemblies 107 and 109, includes the rotor 111 and the rotor shaft 113. Also visible in this figure is stator 115.

Also visible in FIG. 1 is the gearbox housing. It will be appreciated that the gearbox can be configured in a variety of ways, depending primarily on the way in which the gearbox housing is to be coupled to the motor housing as well as the gearbox configuration itself (e.g., number of gears, type of clutch, cooling system, etc.). In the illustrated configuration, the gearbox housing includes a rear casing member 117, which may be attached directly to motor end cap 103, and a front casing member 119. Within the gearbox housing is the input shaft 121, which is coupled to the rotor shaft 113, for example using spline gears. The input shaft 121 is coupled via a plurality of gears 123 to output drive shaft 125. Input shaft 121 is supported on either end by bearing assemblies 127 and 129, while output drive shaft 125 is supported on either end by bearing assemblies 131 and 133.

Minor mismatches between rotor shaft 113 and gearbox input shaft 121 in a motor/gearbox assembly such as that shown in FIG. 1 can lead to excessive drive train vibrations and accelerated motor and gearbox wear. As a result of such accelerated wear, a variety of drive train components (e.g., bearing assemblies, seals, drive train gears, rotor/input shafts, etc.) may fail prematurely, requiring early replacement. As a consequence, vehicle reliability decreases while driving up maintenance costs.

In part, the mismatch between rotor shaft 113 and gearbox input shaft 121 is due to the motor assembly and the gearbox assembly utilizing separate enclosures, thus allowing the two assemblies to be misaligned. Additionally, since the rotor shaft and the input drive shaft are held in place within their respective enclosures using different bearing sets, i.e., bearing assemblies 107/109 for shaft 113 and bearing assemblies 127/129 for shaft 121, it is easy for a minor axial misalignment between the two drive shafts to occur.

While there are a variety of techniques that may be used to improve the alignment of the motor and gearbox assemblies in general, and the rotor and input drive shafts in particular, typically these techniques add complexity, and thus cost, to the manufacturing process. The approach described herein, however, reduces alignment errors by reducing assembly complexity, and therefore also reduces manufacturing cost.

In general these goals are achieved by (i) locating the input drive shaft and the first gear of the gearbox within a single piece housing; (ii) reducing the number of bearing assemblies from the four coaxial bearing assemblies shown in FIG. 1 (i.e., assemblies 107, 109, 127 and 129) to three coaxial bearing assemblies; and (iii) utilizing the gearbox's single piece housing as the front end cap for the motor.

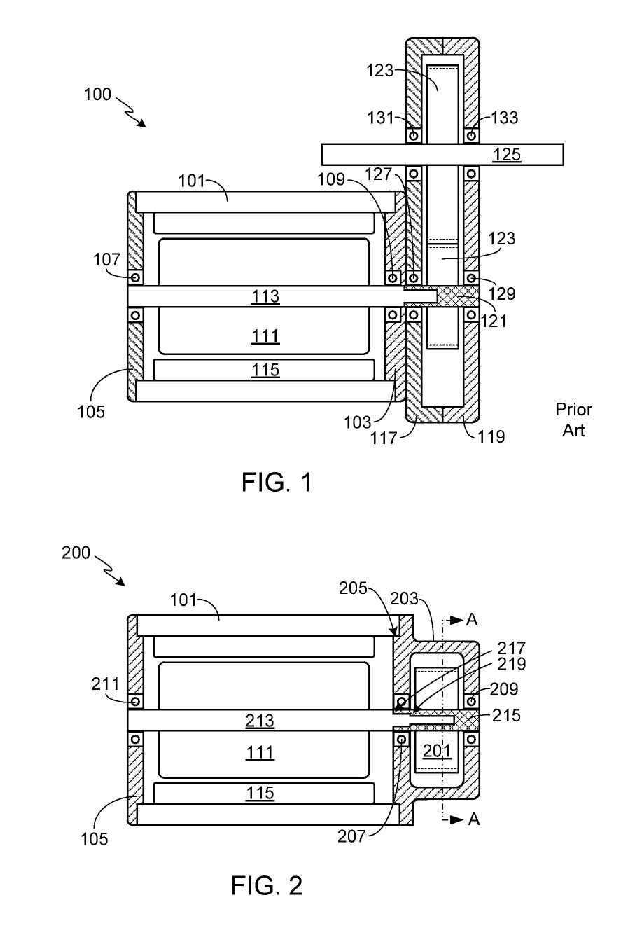

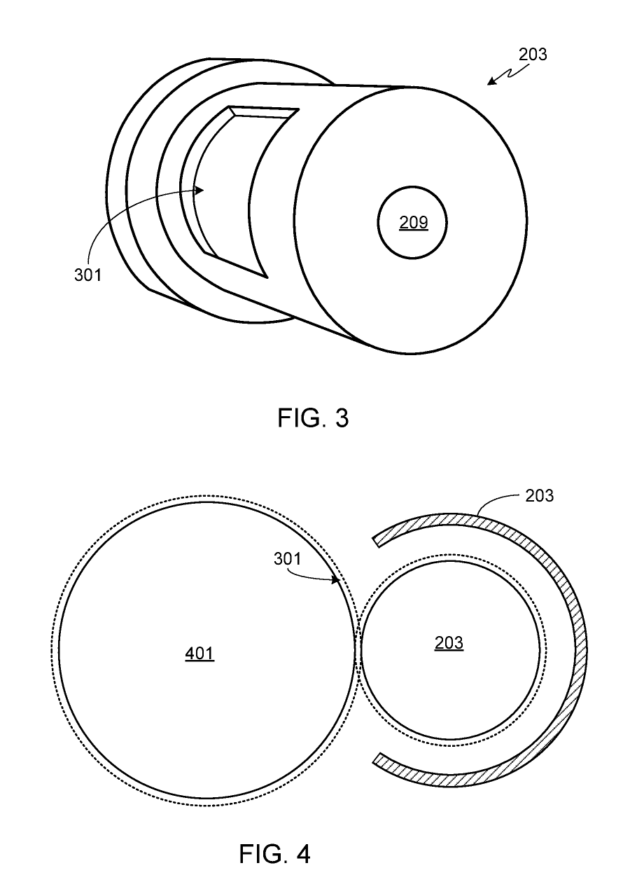

FIG. 2 provides a simplified cross-sectional view of a preferred embodiment of the motor/gearbox assembly of the invention. In assembly 200 the primary drive gear 201 of the gearbox is housed within a rigid, single piece enclosure 203. It should be understood that while assembly 200 and subsequent embodiments of the invention show a single drive gear 201, enclosure 203 may house additional gears. Additionally, and as shown in FIGS. 3 and 4, enclosure 203 includes an access opening 301 that provides a means for inserting drive gear 201 into housing 203 as well as accessing the gear as shown in FIG. 4. In the cross-sectional view shown in FIG. 4, taken along plane A-A, a gear 401 is shown using aperture 301 to access gear 201. To provide clarity, the teeth of gears 201 and 401 are not shown in the figures.

In addition to providing a rigid, single piece housing 203 for drive gear 201, enclosure 203 also serves as the end cap for the motor assembly. Enclosure 203 may be mechanically coupled to motor casing 101 using any of a variety of techniques, although preferably a plurality of bolts, not shown, is used. To insure accurate alignment of housing 203 to motor casing 101, preferably the two housings utilize matched, mating surfaces or other alignment features. In the illustrated embodiment, lip 205 is designed to fit within casing 101, thereby providing a means of accurately positioning gear housing 203 relative to the motor casing. Note that other means, alone or in combination with the collar provided by lip 205, may be used to insure accurate alignment of the motor and gear assemblies.

As shown in FIG. 2, the motor/gearbox assembly of the present invention uses three, rather than four, bearing assemblies. Two of the bearing assemblies, specifically bearing assemblies 207 and 209, are mounted within gearbox enclosure 203. The third bearing assembly 211 is mounted within motor housing end cap 105. Bearing assemblies 207 and 211 support motor rotor shaft 213 while gearbox input shaft 215 is supported by bearing assemblies 207 and 209.

By reducing the number of bearing assemblies and using one of the bearing assemblies to support both the rotor shaft 213 and the gearbox input shaft 215, it is easier to achieve the desired level of alignment between the rotor shaft and the gearbox input shaft. Furthermore, this configuration is both easier to manufacture and requires one less bearing assembly than used in conventional assembly, thereby reducing manufacturing cost as well as improving shaft alignment and assembly reliability. Note that in assembly 200, it is the outer surface of drive gear input shaft 215 that is captured by bearing assembly 207.

In order to avoid the premature breakdown and failure of the bearing assemblies, seals and other drive train components, it is essential that the rotor shaft and the gearbox input shaft are coaxially aligned such that there is negligible offset and angular misalignment. Preferably the end portion of one of the shafts is configured to be inserted within the bore of the second shaft with the two shafts utilizing any of a variety of techniques to achieve both accurate coaxial alignment and efficient torque transference. Typical techniques include (i) tapering the end portion of the first shaft to match a similar feature in the bore of the second shaft, (ii) including one or more steps in the tapered portion of the first shaft with matching features machined into the bore of the second shaft, and/or (iii) the use of splines. In assembly 200, the end portion of rotor shaft 213 fits within the bore of gearbox input shaft 215 and achieves accurate coaxial alignment using a first step 217 and a second step 219. Although not visible in the view shown in FIG. 2, the mating surfaces of the two shafts are splined, thereby insuring that motor torque is efficiently transferred to input shaft 215.

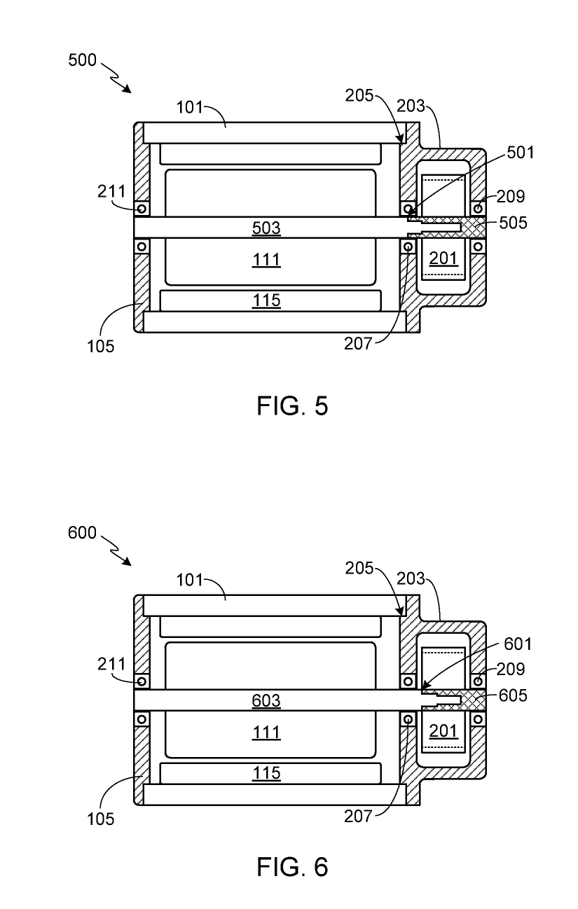

FIG. 5 illustrates a minor modification of the assembly shown in FIG. 2. In this embodiment, the juncture 501 between the rotor shaft 503 and the gearbox input shaft 505 is is located within bearing assembly 207 as shown.

FIG. 6 illustrates a minor modification of the assembly shown in FIG. 2. In this embodiment, the juncture 601 between the rotor shaft 603 and the gearbox input shaft 605 is is located within gear enclosure 203. As a result, the outer surface of rotor shaft 603 is in contact with bearing assemblies 207 and 209 as shown.

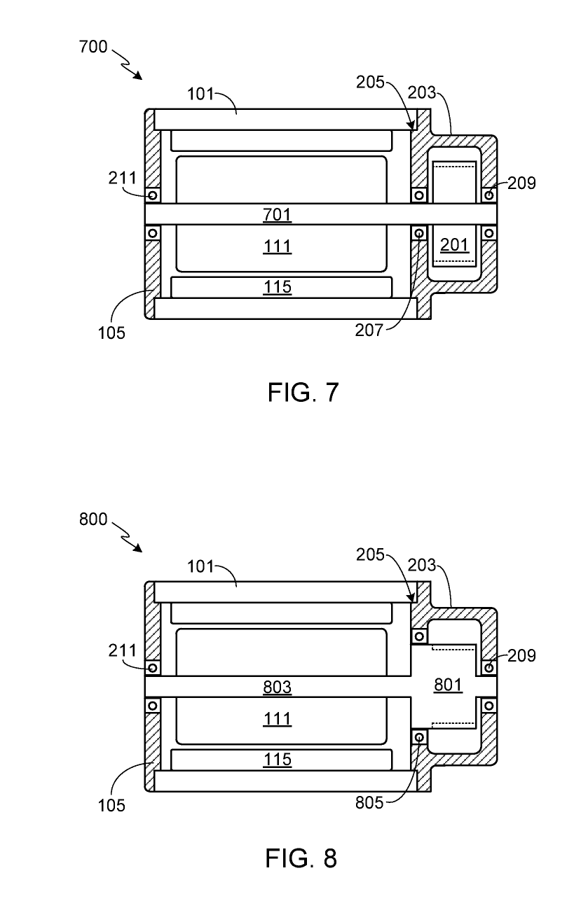

FIG. 7 illustrates a minor modification of the assembly shown in FIG. 2 in which a single shaft 701 serves the dual functions of the rotor shaft and the input shaft for the primary drive gear. As such, shaft 701 is supported by all three bearing assemblies 207, 209 and 211.

FIG. 8 illustrates a minor modification of the assembly shown in FIG. 7. In this embodiment, drive gear 801 is integral to shaft 803, i.e., fabricated as a single piece. As a result, shaft 803 serves both as the rotor shaft and the primary drive shaft for the gearbox. Preferably the assembly is configured such that bearing assembly 805 is large enough to slide over gear 801, thereby simplifying both the manufacture and repair of the assembly. Note that bearing assembly 805 supports a non-toothed portion of drive gear 801 as illustrated.

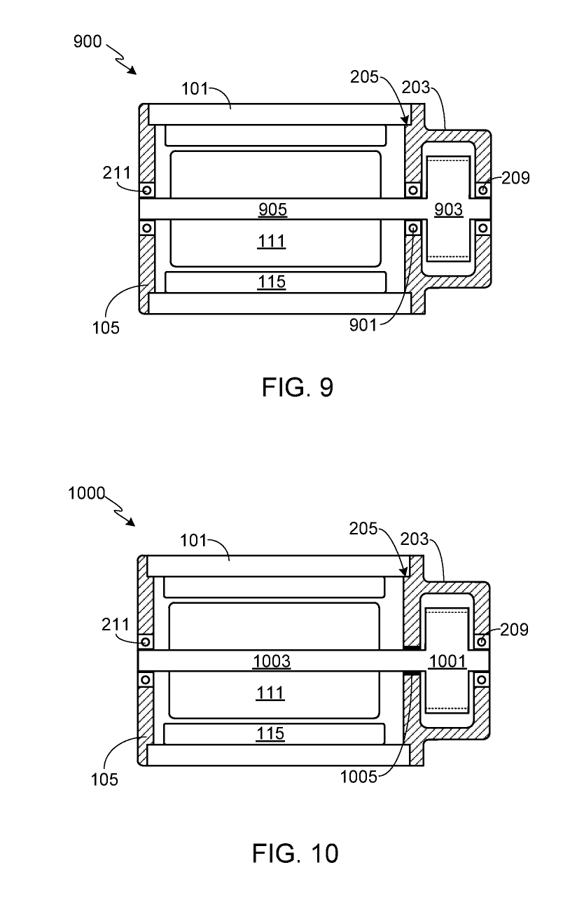

FIG. 9 illustrates a minor modification of the assembly shown in FIG. 8. As in assembly 800, the drive gear is integral to the rotor shaft, i.e., fabricated as a single piece. Unlike assembly 800, however, in assembly 900 bearing assembly 901 is not large enough to pass over drive gear 903. As a result, bearing assembly 901 must be fitted onto shaft 905 prior to rotor assembly and is not readily serviceable after rotor assembly.

FIG. 10 illustrates a minor modification of the assembly shown in FIG. 9. As with assemblies 800 and 900, in assembly 1000 drive gear 1001 is integral to rotor shaft 1003, i.e., fabricated as a single piece. In assembly 1000, however, bearing assembly 1005 is comprised of a simple two piece thin wall bearing, thus making all three bearings readily serviceable.

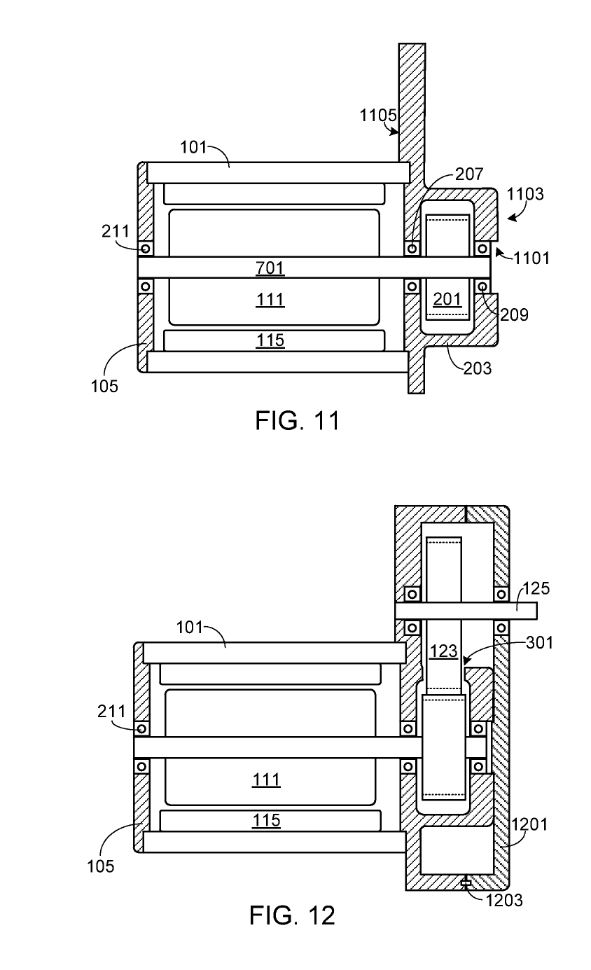

Each of the embodiments illustrated in FIGS. 2-10 and described above include all of the basic features of the invention, specifically (i) locating the input drive shaft and the first gear of the gearbox within a single piece housing, (ii) using only three bearing assemblies to support both the rotor shaft and the input drive shaft, and (iii) utilizing the gearbox's single piece housing as the front end cap for the motor. It should be understood that the rigid, single piece gear housing of any of these embodiments may be modified without departing from the invention. For example, gear housing 203 may include one or more features that allow other components to be easily and accurately coupled to the motor/gear assembly. FIG. 11, which is based on assembly 700, includes a feature 1101 machined onto the front surface 1103 of gear housing 203. Additionally, the rear portion 1105 of housing 203 extends beyond the motor casing, thus providing a mounting surface. FIG. 12 illustrates an assembly in which an outer gearbox casing 1201 has been attached to the mounting surface of gear housing portion 1105, and accurately positioned and indexed using feature 1101 and a single locating pin 1203. Note that in FIG. 12 the motor/gear assembly has been rotated so that opening 301 within the primary gear housing is visible.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A motor assembly, comprising:
a stator contained within a motor enclosure, said motor enclosure comprising a motor casing, a first end cap and a second end cap;
a rotor shaft, wherein said rotor shaft passes between said first end cap and said second end cap of said motor enclosure;
a rotor mounted to said rotor shaft;
a drive gear input shaft, said drive gear input shaft coaxial with said rotor shaft;
a drive gear mounted to said drive gear input shaft;
a drive gear enclosure comprising a first drive gear enclosure end wall and a second drive gear enclosure end wall and a drive gear enclosure side wall, wherein said drive gear enclosure side wall connects said first drive gear enclosure end wall to said second drive gear enclosure end wall, wherein said drive gear enclosure is fabricated as a single piece unit, wherein said drive gear is contained within said drive gear enclosure, wherein said drive gear input shaft passes between said first drive gear enclosure end wall and said second drive gear enclosure end wall, wherein said first drive gear enclosure end wall serves as said second end cap of said motor enclosure, wherein said drive gear enclosure is further comprised of a drive gear access aperture, and wherein said drive gear access aperture is located in said drive gear enclosure side wall;
a first bearing assembly supporting a first end portion of said rotor shaft, wherein said first bearing assembly is mounted within said first end cap;
a second bearing assembly interposed between said rotor and said drive gear, wherein said second bearing assembly supports a second end portion of said rotor shaft and a first end portion of said drive gear input shaft, wherein said second bearing assembly is mounted within said first drive gear enclosure end wall, and wherein no additional bearing assemblies are interposed between said rotor and said drive gear; and
a third bearing assembly supporting a second end portion of said drive gear input shaft, wherein said third bearing assembly is mounted within said second drive gear enclosure end wall.

2. The motor assembly of claim 1, wherein an end section of said second end portion of said rotor shaft is configured to fit within a bore of an end section of said first end portion of said drive gear input shaft.

3. The motor assembly of claim 2, said end section of said rotor shaft further comprising a male spline, and said bore of said end section of said drive gear input shaft further comprising a female spline configured to match said male spline of said end section of said rotor shaft.

4. The motor assembly of claim 2, wherein said end section of said rotor shaft is comprised of a tapered region configured to fit within said bore of said end section of said drive gear input shaft upon insertion of said end section of said rotor shaft into said bore of said end section of said drive gear input shaft.

5. The motor assembly of claim 4, wherein said tapered region of said end section of said rotor shaft is comprised of at least one step, wherein said bore of said end section of said drive gear input shaft is comprised of at least one feature configured to align with said at least one step of said tapered region of said end section of said rotor shaft upon insertion of said end section of said rotor shaft into said bore of said end section of said drive gear input shaft.

6. The motor assembly of claim 1, wherein an end section of said first end portion of said drive gear input shaft is configured to fit within a bore of an end section of said second end portion of said rotor shaft.

7. The motor assembly of claim 6, said end section of said drive gear input shaft further comprising a male spline, and said bore of said end section of said rotor shaft further comprising a female spline configured to match said male spline of said end section of said drive gear input shaft.

8. The motor assembly of claim 6, wherein said end section of said drive gear input shaft is comprised of a tapered region configured to fit within said bore of said end section of said rotor shaft upon insertion of said end section of said drive gear input shaft into said bore of said end section of said rotor shaft.

9. The motor assembly of claim 8, wherein said tapered region of said end section of said drive gear input shaft is comprised of at least one step, wherein said bore of said end section of said rotor shaft is comprised of at least one feature configured to align with said at least one step of said tapered region of said end section of said drive gear input shaft upon insertion of said end section of said drive gear input shaft into said bore of said end section of said rotor shaft.

10. The motor assembly of claim 1, wherein said rotor shaft and said drive gear input shaft are fabricated as a single drive shaft.

11. The motor assembly of claim 10, wherein said single drive shaft and said drive gear are fabricated as a single piece drive gear unit.

12. The motor assembly of claim 1, said drive gear input shaft further comprising a male spline, and said drive gear further comprising a female spline configured to match said male spline of said drive gear input shaft.

13. The motor assembly of claim 1, wherein at least one of said first, second and third bearing assemblies is comprised of a two piece thin wall bearing.

14. The motor assembly of claim 1, wherein said first drive gear enclosure end wall includes a positioning feature used to align said first drive gear enclosure end wall with said motor casing during assembly.

15. The motor assembly of claim 1, wherein an outer surface of said first end portion of said drive gear input shaft is in contact with said second bearing assembly, and wherein said first end portion of said drive gear input shaft is distal from said second end portion of said drive gear input shaft.

16. The motor assembly of claim 1, wherein an outer surface of said second end portion of said rotor shaft is in contact with said second bearing assembly, and wherein said second end portion of said rotor shaft is distal from said first end portion of said rotor shaft.

17. The motor assembly of claim 1, wherein a juncture between said rotor shaft and said drive gear input shaft is positioned within said second bearing assembly.

18. The motor assembly of claim 1, further comprising an outer gearbox casing attached to said first drive gear enclosure end wall.
